(19) United States
(12) Patent Application Publication
(10) Pub. No.: US 2018/0238822 A1
(43) Pub. Date: Aug. 23, 2018

(54) GAS SENSING APPARATUS AND A MANUFACTURING PROCESS THEREOF

(71) Applicant: Industrial Technology Research Institute, Hsinchu (TW)

(72) Inventors: Kuan-Wei Chen, Taichung City (TW); Chih-Sheng Lin, Tainan City (TW); Erh-Hao Chen, Changhua County (TW); Sih-Han Li, New Taipei City (TW); Shyh-Shyuan Sheu, Taipei City (TW)

(73) Assignee: Industrial Technology Research Institute, Hsinchu (TW)

(21) Appl. No.: 15/955,691

(22) Filed: Apr. 18, 2018

Related U.S. Application Data
(63) Continuation-in-part of application No. 14/958,856, filed on Dec. 3, 2015, now abandoned.

(30) Foreign Application Priority Data
Oct. 27, 2015 (TW) 104135207

(51) Int. Cl. G01N 27/12

(52) U.S. Cl. CPC G01N 27/127; G01N 27/122

(57) ABSTRACT

A gas sensing apparatus including a gas sensor, a gas determining circuit and a gas database is provided. The gas sensor includes at least two nanowire sensors. The gas sensor is configured to sense multiple gases and output a plurality of sensing signals. The gas determining circuit is coupled to the gas sensor. The gas determining circuit is configured to receive the sensing signals and determine types of the gases according to reference data and the sensing signals. The gas database is coupled to the gas determining circuit. The gas database stores the reference data and outputs the reference data to the gas determining circuit. Each of the nanowire sensors includes at least one nanowire. Structural properties of the nanowires are different.

### CROSS-REFERENCE TO RELATED APPLICATION

This application is a continuation-in-part application of and claims the priority benefit of a prior application Ser. No. 14/958,856, filed on Dec. 3, 2015, now pending. The prior application Ser. No. 14/958,856 claims the priority benefit of Taiwan application no. 104135207, filed on Oct. 27, 2015. The entirety of each of the above-mentioned patent applications is hereby incorporated by reference herein and made a part of this specification.

### TECHNICAL FIELD

The disclosure relates to a gas sensing apparatus and a gas sensing method.

### BACKGROUND

Three important layers in the Internet of Things (IoT) are a sensing layer, a network layer, and an application layer, and an important component in the sensing layer is the sensor. Thus, as the technologies of IoT develop, the demands for sensors also continuously increase.

Currently, common gas sensors include metal oxide semiconductor gas sensors, electrochemical gas sensors, solid state electrolyte gas sensors, and catalytic combustion gas sensors, etc. Most gas sensors are designed to detect one gas. Also, except for the electrochemical gas sensors, sensors in other frameworks require a heating circuit, making the sensors have a higher power consumption and a larger size and not suitable for miniature and low power consumption products. Also, because of heating, such sensors are not suitable for highly integrated products or products that are used close to human bodies.

### SUMMARY

A gas sensor apparatus according to an embodiment of the disclosure includes a gas sensor, a gas determining circuit, and a gas database. The gas sensor includes at least two nanowire sensor groups. The gas sensor is configured to sense a plurality of gases and output a plurality of sensing signals. The gas determining circuit is coupled to the gas sensor. The gas determining circuit is configured to receive the sensing signals and determine types of the gases based on reference data and at least one of the sensing signals. The gas database is coupled to the gas determining circuit. The gas database is configured to store the reference data and output the reference data to the gas determining circuit. Each of the nanowire sensor groups comprises a plurality of nanowire sensors, each of the nanowire sensors comprises at least one nanowire, and the nanowires have different structural properties. The nanowires in each of the nanowire sensor groups are made of the same sensing material. The sensing material of the nanowires in one of the nanowire sensor groups is the same as the sensing material of the nanowires in another one of the nanowire sensor groups.

A gas sensor apparatus according to an embodiment of the disclosure includes a gas sensor, a gas determining circuit, and a gas database. The gas sensor includes at least two nanowire sensor groups. The gas sensor is configured to sense a plurality of gases and output a plurality of sensing signals. The gas determining circuit is coupled to the gas sensor. The gas determining circuit is configured to receive the sensing signals and determine types of the gases based on reference data and at least one of the sensing signals. The gas database is coupled to the gas determining circuit. The gas database is configured to store the reference data and output the reference data to the gas determining circuit. Each of the nanowire sensor groups comprises a plurality of nanowire sensors, each of the nanowire sensors comprises at least one nanowire, and the nanowires have different structural properties. The nanowires in each of the nanowire sensor groups are made of the same sensing material. The sensing material of the nanowires in one of the nanowire sensor groups is different from the sensing material of the nanowires in another one of the nanowire sensor groups.

A manufacturing process of a gas sensing apparatus, wherein the gas sensing apparatus has n nanowire sensor groups and n is an integer greater than 1, includes the following steps: providing a substrate; disposing a bottom isolation layer on the substrate; forming a plurality of nanowires of one nanowire sensor group on the bottom isolation layer; repeating to form a plurality of nanowires of n−1 nanowire sensor groups on the bottom isolation layer; and exposing the nanowires of the nanowire sensor group used for sensing gases.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic block view illustrating a gas sensing apparatus according to an embodiment of the disclosure.

FIG. 2 is a schematic view illustrating a gas sensing apparatus according to another embodiment of the disclosure.

FIG. 3 is a schematic view illustrating a structure of a gas sensor in the embodiment of FIG. 2.

FIG. 4 is a schematic view illustrating a nanowire in the embodiment of FIG. 3.

FIG. 5 is a bar chart illustrating different gas responses of nanowires with different widths to different gases in the embodiment of FIG. 2.

FIG. 6 is a normalized curve view illustrating gas responses of nanowires with different widths to different gases in the embodiment of FIG. 2.

FIGS. 7 to 10 are normalized triangular radar views illustrating different gas responses of nanowires with different widths to different gases in the embodiment of FIG. 2.

FIG. 11 is a schematic view illustrating a gas sensing apparatus according to another embodiment of the disclosure.

FIG. 12 is a schematic view illustrating a gas sensing apparatus according to another embodiment of the disclosure.

FIG. 13 is a bar chart illustrating different gas responses of nanowires with different widths to different gases in the embodiment of FIG. 2.

FIG. 14 is an internal schematic view illustrating a gas determining circuit and a gas database according to an embodiment of the disclosure.

FIG. 15 is an internal schematic view illustrating a gas determining circuit and a gas database according to another embodiment of the disclosure.

FIG. 16 is a flowchart illustrating a gas sensing method according to an embodiment of the disclosure.

FIG. 17 is a flowchart illustrating a gas sensing method according to another embodiment of the disclosure.

FIG. 18 is a flowchart illustrating a gas sensing method according to another embodiment of the disclosure.

FIG. 19 is a schematic view illustrating a structure of a gas sensor in one embodiment of the disclosure.

FIG. 20 is a cross-sectional view of the gas sensor along section line A-A′ in FIG. 19.

FIG. 21 is a cross-sectional view of a gas sensor in another embodiment of the disclosure.

FIG. 22 is a schematic view illustrating a structure of a gas sensor in another embodiment of the disclosure.

FIG. 23 is a cross-sectional view of the gas sensor along section line B-B′ in FIG. 22.

FIG. 24 is a cross-sectional view of a gas sensor in yet another embodiment of the disclosure.

FIG. 25A to FIG. 25E shows a flow chart illustrating a process of manufacturing nanowire sensor groups according to an embodiment of the disclosure.

FIG. 26 is a flow chart illustrating a process of manufacturing nanowire sensor groups according to another embodiment of the disclosure.

FIG. 27 is a flow chart illustrating a process of manufacturing nanowire sensor groups according to another embodiment of the disclosure.

### DETAILED DESCRIPTION OF DISCLOSED EMBODIMENTS

Throughout the text (including claims), the term “couple” refers to any direct or indirect connecting means. For example, if it is described that a first device is coupled to a second device, it shall be construed that the first device may be directly connected to the second device or indirectly connected to the second device through another device or a connecting means. In addition, the term “signal” may refer to at least one current, voltage, charge, temperature, data, electromagnetic wave, or any other one or more signals.

The disclosure provides a gas sensing apparatus and a gas sensing method for determining a plurality of types of gases.

In the exemplary embodiment of the disclosure, the gas sensor of the gas sensing apparatus includes at least two nanowire sensors to sense a plurality of gases. The nanowire sensors include nanowires having different structural properties. Thus, the gas sensing apparatus is capable of determining the types of the gases.

In an exemplary embodiment of the disclosure, a gas sensing apparatus includes a plurality of nanowires. In a method for the gas sensing apparatus to determine the types of the gases, the types of the gases are determined based on the concept that nanowires having different structural properties have different gas responses to the same gas, whereas nanowires having the same structural properties have different gas responses to different gases. Based on this concept, a plurality of nanowire sensors may be manufactured on one chip to detect and determine concentrations and types of gases. The gas sensing apparatus according to the exemplary embodiment of the disclosure has a low area cost and a quick response, and is capable of monitoring and determining a plurality of gases simultaneously. Several embodiments are provided below for the disclosure. However, the disclosure is not limited to the embodiments described in the following. Besides, different embodiments may also be suitably combined.

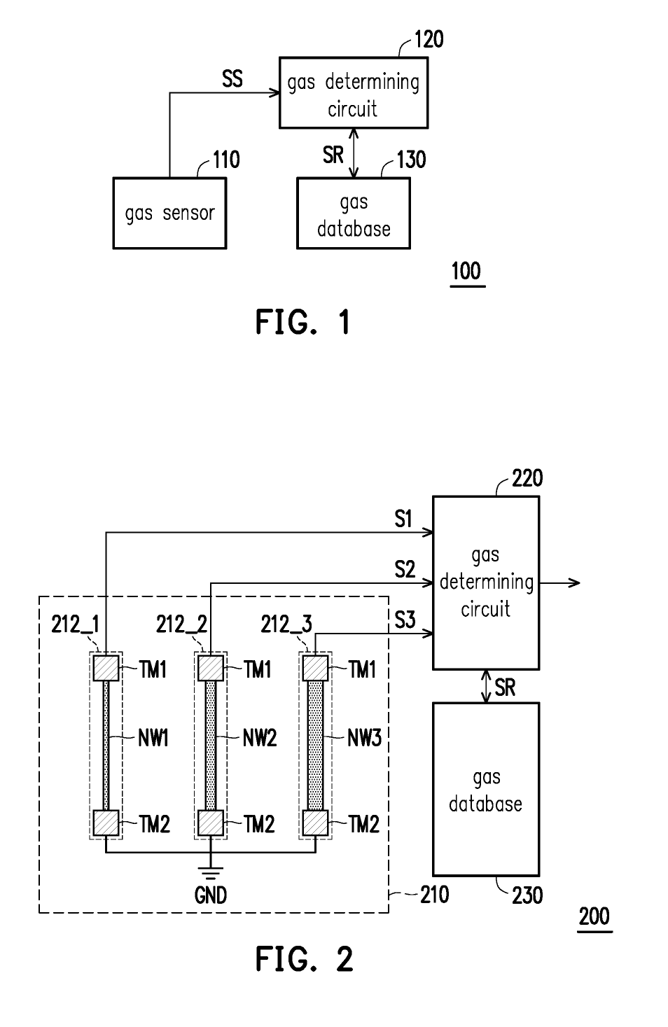

FIG. 1 is a schematic block view illustrating a gas sensing apparatus according to an embodiment of the disclosure. Referring to FIG. 1, a gas sensor apparatus 100 includes a gas sensor 110, a gas determining circuit 120, and a gas database 130. The gas sensor 110 is configured to sense a plurality of gases and outputs sensing signals SS to the gas determining circuit 120. The gas determining circuit 120 is coupled to the gas sensor 110. The gas determining circuit 120 is configured to receive the sensing signal SS and receive reference data SR from the gas database 130, so as to determine types of the sensed gases based on the reference data SR and the sensing signals SS. The gas database 130 is coupled to the gas determining circuit 120. The gas database 130 is configured to store the reference data SR and output the reference data SR to the gas determining circuit 120. In this embodiment, the gas database 130 is electrically connected to the gas sensing apparatus 100 in a wired or wireless manner. For example the gas database 130 is a cloud database. However, the disclosure is not limited thereto. In this embodiment, the reference data SR include gas responses (%) of nanowires formed of different materials and having different structural properties and doped concentrations to different gases, and the reference data SR are, for example, stored in advance in the gas database 130 before the gases are sensed, or adjusted dynamically based on a sensing result when the gases are sensed. However, the disclosure does not intend to limit the way of storing the reference data.

In this embodiment, the gas sensor 110 includes at least two nanowire sensors, for example. Each of the nanowire sensors includes a nanowire, and the nanowires have different structural properties. The structural properties of the nanowires include at least one of width, length, height, and profile. In an embodiment, the nanowires of the respective nanowire sensors may, for example, have different widths but the same length. Or, in an embodiment, the nanowires of the respective nanowire sensors may have different profiles but the same length. In an embodiment, the nanowires of the respective nanowire sensors may, for example, have different doped concentrations. The disclosure does not intend to impose a limitation in this regard. For example, the nanowires of the respective nanowire sensors may be ZnO nanowires, whereas the doped concentrations of the respective ZnO nanowires are different. The disclosure does not intend to limit the materials of the nanowires, and the materials and concentrations of the nanowires may be adjusted based on the gases to be sensed.

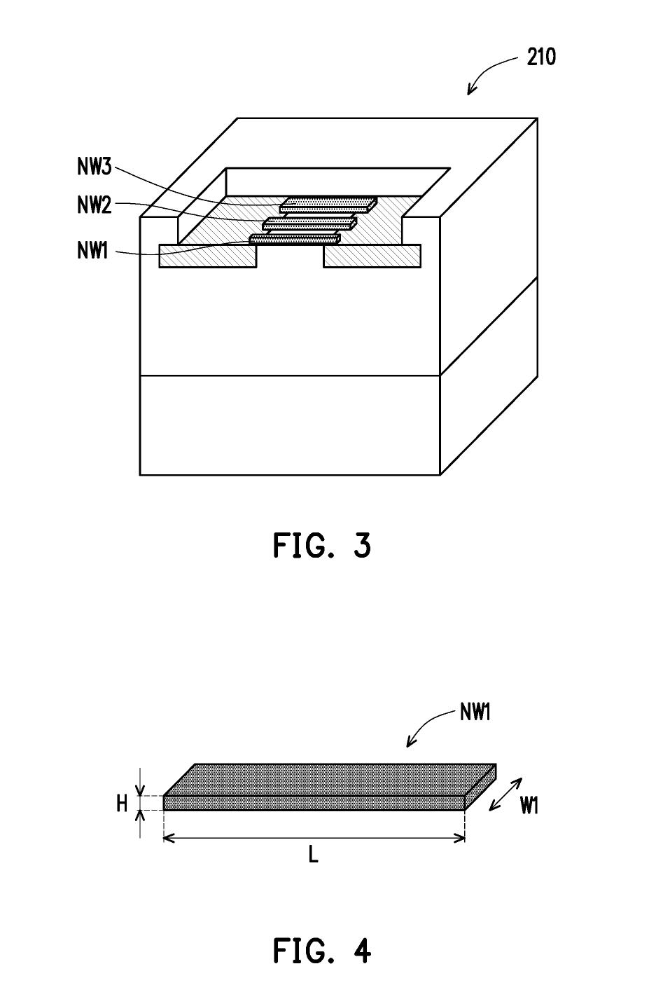

FIG. 2 is a schematic view illustrating a gas sensing apparatus according to another embodiment of the disclosure. FIG. 3 is a schematic view illustrating a structure of a gas sensor in the embodiment of FIG. 2. FIG. 4 is a schematic view illustrating a nanowire in the embodiment of FIG. 3. Referring to FIGS. 2 to 4, a gas sensor apparatus 200 includes a gas sensor 210, a gas determining circuit 220, and a gas database 230. In this embodiment, the gas sensor 210 includes a plurality of nanowire sensors 212_1, 212_2, and 212_3. However, the number of the nanowire sensors shall not serve to limit the disclosure. The nanowire sensors 212_1, 212_2, and 212_3 are configured to sense gases, so as to output sensing signals S1, S2, and S3 to the gas determining circuit 220. In this embodiment, each nanowire sensor includes a first terminal TM1 and a second terminal TM2. The first terminals TM1 of the nanowire sensors 212_1, 212_2, and 212_3 are respectively coupled to the gas determining circuit 220. The gas determining circuit 220 may provide a common voltage to the first terminals TM1 of the nanowire sensors 212_1, 212_2, and 212_3, or respectively provide different voltages to the first terminals TM1 of the nanowire sensors 212_1, 212_2, and 212_3 based on practical compensation needs. The second terminals T2 of the nanowire sensors 212_1, 212_2, and 212_3 are coupled to each other, and may be coupled to the same reference potential (e.g., a ground voltage GND), or may alternatively be coupled to different reference potentials based on practical compensation needs. In this embodiment, the nanowire sensors 212_1, 212_2, and 212_3 respectively output the sensing signals S1, S2, and S3 to the gas determining circuit 220 through the first terminals T1.

In this embodiment, the nanowire sensors 212_1, 212_2, and 212_3 respectively include nanowires NW1, NW2, and NW3 having the same profile but different widths, for example. For example, FIG. 4 illustrates the nanowire NW1 of the nanowire sensor 212_1, for example, and structural properties of the nanowire NW1 include a width W1, a length L, and a height H. In this embodiment, the nanowire NW1 is a nanowire wire having a rectangular cross-sectional area in an extending direction of the length L in the respect of profile. However, the disclosure is not limited thereto. In an embodiment, the nanowire NW1 may also be a nanowire having a circular, elliptical, rhombus, trapezoid, or square shape or similar shapes in the extending direction of the length L in the respect of profile. For the nanowire whose cross-sectional area is circular, the width thereof refers to a length of diameter. In this embodiments, the nanowires NW2 and NW3 are nanowires having widths different from the width W1 of the nanowire NW1, while the rest structural properties of the nanowire NW1 apply to the nanowires NW2, and NW3, for example. In this embodiment, the nanowires NW1, NW2, and NW3 having different structural properties have different responses to the same gas.

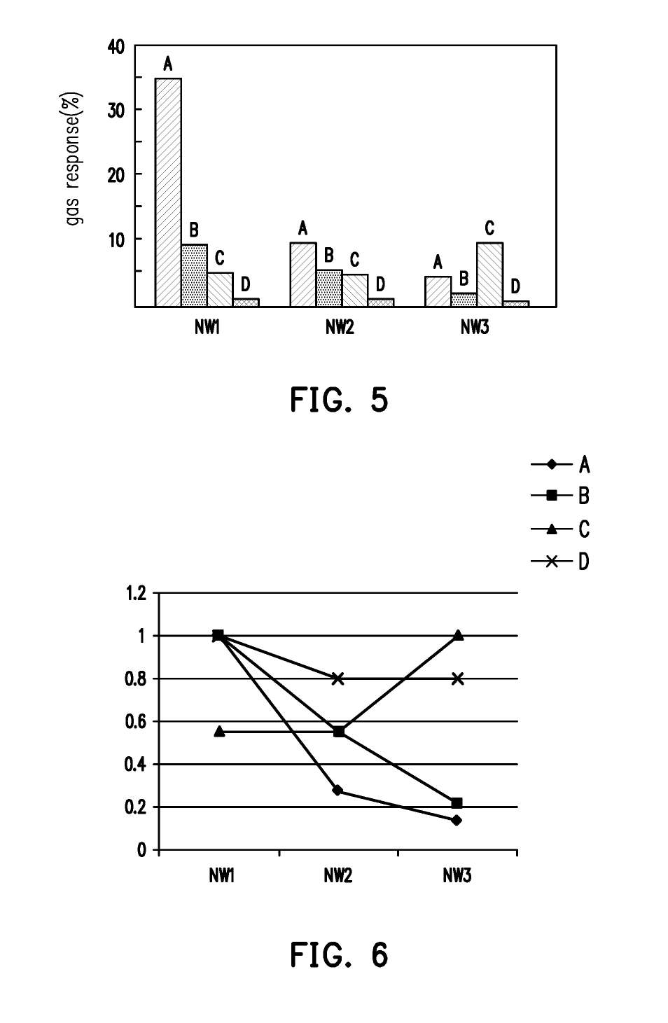

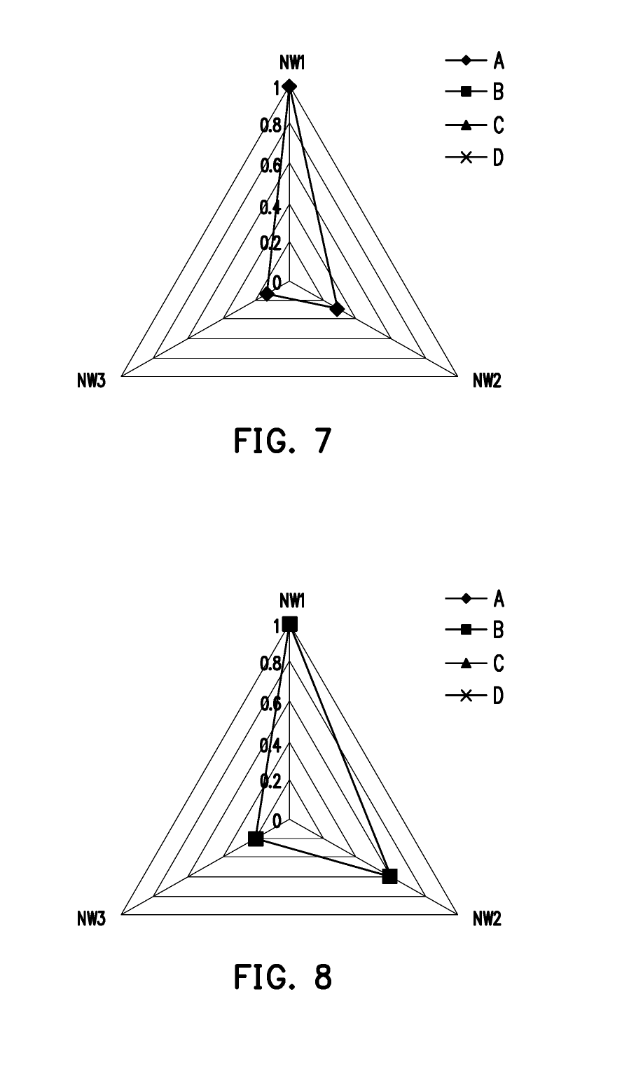

FIG. 5 is a bar chart illustrating different gas responses of nanowires with different widths to different gases in the embodiment of FIG. 2. FIG. 6 is a normalized curve view illustrating different gas responses of nanowires with different widths to different gases in the embodiment of FIG. 2. FIGS. 7 to 10 are normalized triangular radar views illustrating different gas responses of nanowires with different widths to different gases in the embodiment of FIG. 2. In this embodiment, each nanowire is configured to sense a plurality of gases. For example, the nanowire NW1 is configured to sense a first gas A, a second gas B, a third gas C, and a fourth gas D, and so are the nanowires NW2 and NW3. However, the number of sensible gases of the disclosure is not limited thereto. From left to right, FIG. 5 illustrates combinations of gas responses of the nanowires NW1, NW2, and NW3 to the first gas A, the second gas B, the third gas C, and the fourth gas D. In this embodiment, the first gas A, the second gas B, the third gas C, and the fourth gas D are respectively H₂, NH₃, isobutane (i-butane), and CH₄, for example. However, the types of the gases described herein serve as an example, and shall not be construed as a limitation of the disclosure.

As shown in FIGS. 5 to 10, the combinations of the gas responses of the nanowires NW1, NW2, and NW3 of the nanowire sensors 212_1, 212_2, and 212_3 to the first gas A, the second gas B, the third gas C, and the fourth gas D are different. For example, in FIG. 5, the first combination of gas responses in the leftmost is the combination of gas responses of the nanowire NW1 to the four gases, the second combination of gas responses in the middle is the combination of gas responses of the nanowire NW2 to the four gases, and the third combination of gas responses in the rightmost is the combination of gas responses of the nanowire NW3 to the four gases, and the three combinations of gas responses are different from each other. Also, in this embodiment, each of the nanowire sensors has different gas responses to the first gas A, the second gas B, the third gas C, and the fourth gas D. For example, the gas responses of the nanowire NW1 to the first gas A, the second gas B, the third gas C, and the fourth gas D are respectively 35%, 8%, 4%, and 1%, so the gas responses are different from each other. The different gas responses of the nanowires NW2 and NW3 to different gases may be inferred from FIG. 5. However, values of the gas responses shall not be construed as a limitation of the disclosure.

In this embodiment, the gas database 230 includes the reference data SR storing the gas responses shown in FIG. 5, for example, as basis for the gas determining circuit 220 to determine the types of the gases. As shown in FIGS. 5 to 10, it can be known that the nanowires NW1, NW2, and NW3 of the nanowire sensors 212_1, 212_2, and 212_3 have significant differences in the gas responses to different gases. Thus, an accuracy of determination of the gas determining circuit 220 is improved.

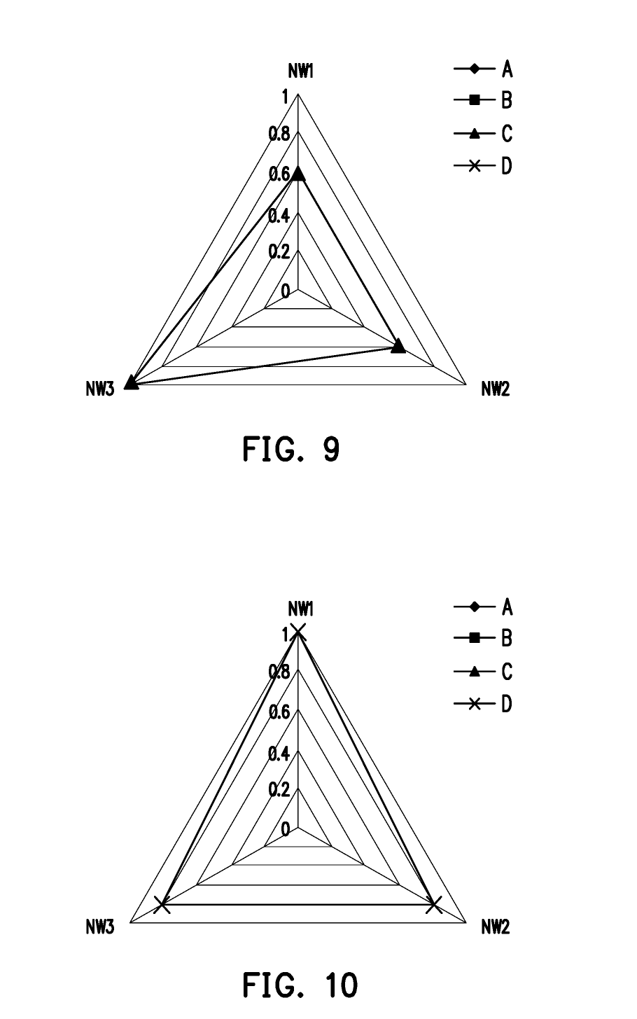

FIG. 6 is a normalized curve view illustrating gas responses of nanowires with different widths to different gases in the embodiment of FIG. 2. From left to right, FIG. 6 illustrates normalized combinations of the gas responses of the nanowires NW1, NW2, and NW3 to the first gas A, the second gas B, the third gas C, and the fourth gas D. As shown in FIG. 6, different gases exhibit different gas responses with respect to the nanowires with different widths. Thus, the types of the first gas A, the second gas B, the third gas C, and the fourth gas D may be determined based on curvature changes shown in FIG. 6, such as ratios of changes of the nanowire NW1, NW2, and NW3. However, the disclosure is not limited thereto. In addition, FIGS. 7 to 10 are triangular radar views illustrating the normalized gas responses of the first gas A, the second gas B, the third gas C, and the fourth gas D with respect to nanowires having different widths. As shown in FIGS. 7 to 10, different types of gases show variations in terms of graphical shapes and sizes. For example, by comparing FIGS. 7 and 8, it can be known that the first gas A and the second gas B have the same gas response with respect to the nanowire NW1, but have different gas responses with respect to the nanowires NW2 and NW3. Particularly, the gas responses of the first gas A and the second gas B with respect to the nanowire NW3 are significantly different. Also, by further comparing FIGS. 9 and 10, it can be known that the third gas C has a higher gas response with respect to the nanowire NW3, while the fourth gas D has a higher gas response with respect to the nanowires NW1, NW2, and NW3. Accordingly, based on FIGS. 7 to 10, it can be known that the first gas A, the second gas B, the third gas C, and the fourth gas D have significant differences in gas responses with respect to the nanowires NW1, NW2, and NW3. Thus, the gas determining circuit 220 may accurately determine the types of the gases based on the reference data SR of the gas responses in combination with the differences in the gas responses determined in FIGS. 6 to 10. However, the determination of the gas determining circuit 220 described herein merely serves as an illustrative purpose and shall not be construed as limiting the disclosure.

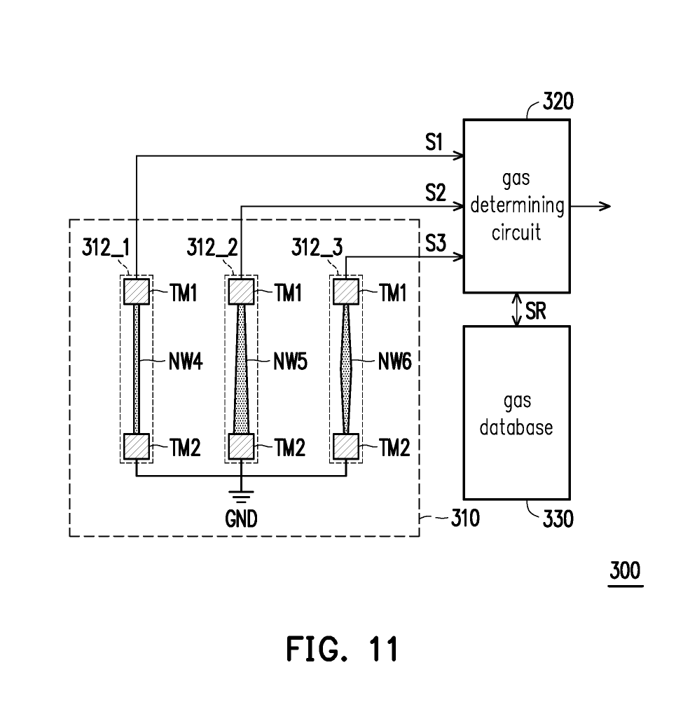

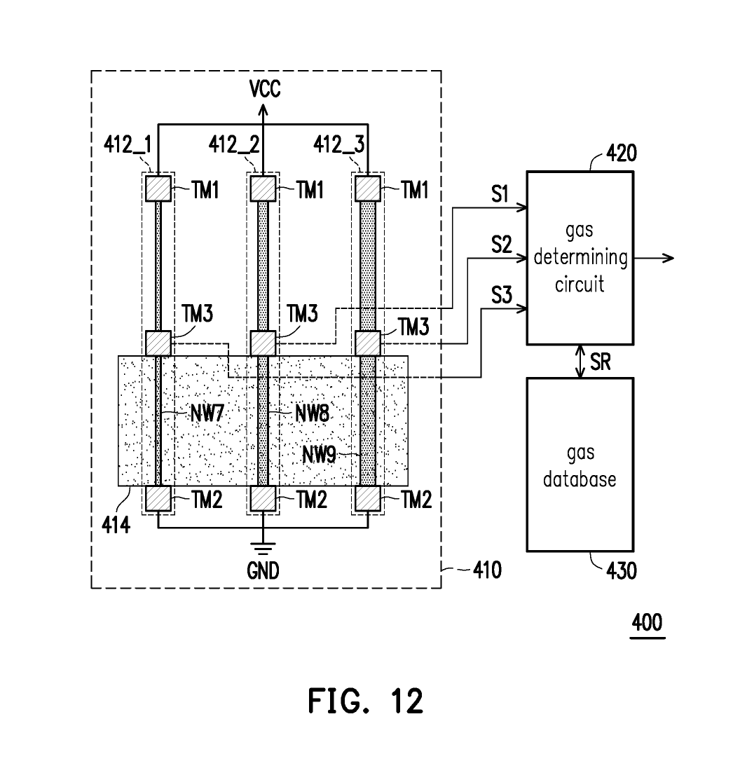

FIG. 11 is a schematic view illustrating a gas sensing apparatus according to another embodiment of the disclosure. The gas sensing apparatus 300 of this embodiment is similar to the gas sensing apparatus 200 in the embodiment shown in FIG. 2, except for a main difference that the nanowires of the respective nanowire sensors of this embodiment have different profiles but the same length, for example.

Based on the direction shown in FIG. 4, a nanowire NW5 in this embodiment is a nanowire having a rectangular cross-sectional area in an extending direction of the height H in the respect of profile, for example, a nanowire NW6 in this embodiment is a nanowire having a trapezoid cross-sectional area in the extending direction of the height H in the respect of profile, for example, whereas a nanowire NW7 in this embodiment is a nanowire having a rhombus cross-sectional area in the extending direction of the height H in the respect of profile, for example. However, the disclosure is not limited thereto. In an embodiment, the cross-sectional areas of the nanowires NW5, NW6, and NW7 in the extending direction of the height H may also be circular, elliptical, or square or similar shapes.

FIG. 12 is a schematic view illustrating a gas sensing apparatus according to another embodiment of the disclosure. A gas sensing apparatus 400 of this embodiment is similar to the gas sensing apparatus 200 in the embodiment shown in FIG. 2, except for a main difference that nanowire sensors 412_1, 412_2, and 412_3 in a gas sensor 410 in this embodiment are arranged as half-bridge structure.

For example, in this embodiment, each nanowire sensor includes the first terminal TM1, the second terminal TM2, and a third terminal TM3. The third terminal TM3 is located between the first terminal TM1 and the second terminal TM2. In this embodiment, the first terminals TM1 of the nanowire sensors 412_1, 412_2, and 412_3 are coupled to each other, and are coupled to a system voltage VCC. The second terminals TM2 of the nanowire sensors 412_1, 412_2, and 412_3 are respectively coupled to each other and are coupled to the ground voltage GND. The third terminals TM3 of the nanowire sensors 412_1, 412_2, and 412_3 are respectively coupled to a gas determining circuit 420. In this embodiment, the nanowire sensors 412_1, 412_2, and 412_3 respectively output the sensing signals S1, S2, and S3 to the gas determining circuit 420 through the third terminals T3. In this embodiment, the nanowires NW7, NW8, and NW9 between the second terminals TM2 and the third terminals TM3 of the respective nanowire sensors are covered with an isolation material 414, so as to be isolated from gases to be sensed. In this embodiment, the isolation material 414 is SiO₂, for example. However, the material of the isolation material 414 shall not be construed as a limitation of the disclosure.

In the embodiments of FIGS. 2, 11, and 12, the gas sensor is designed such that each nanowire is configured to sense a plurality of gases, and the nanowires have different combinations of gas responses to different gases. However, the disclosure is not limited thereto. In other embodiments, the gas sensor may also be designed such that each nanowire senses one gas, and the gas responses may be set as the same. Taking FIG. 12 as an example, it may be designed that each of the nanowire sensors 412_1, 412_2, and 412_3 that are arranged in the half-bridge structure senses one gas. For example, the nanowire sensors 412_1, 412_2, and 412_3 may respectively correspond to the first gas A, the second gas B, and the fourth gas D, and the nanowire sensor 412_1, 412_2, and 412_3 are set to respectively have the same predetermined gas response to the first gas A, the second gas B, and the fourth gas D. Thus, when the gas response measured with one of the sensing signals S1, S2, and S3 is the same as the predetermined gas response, the type of the sensed gas is correspondingly known. For example, when the gas response measured by the nanowire sensor 412_2 is the same as the predetermined gas response, it can be known that the measured gas is the second gas B. Also, the gas determining circuit 420 may further refer to the reference data SR of the gas responses stored in the gas database 430 as basis to determine the types of the gases. However, the design of the gas responses corresponding to the nanowire sensors 412_1, 412_2, and 412_3 and the types and order of the corresponding gases are described herein as an example, and shall not be construed as a limitation of the disclosure.

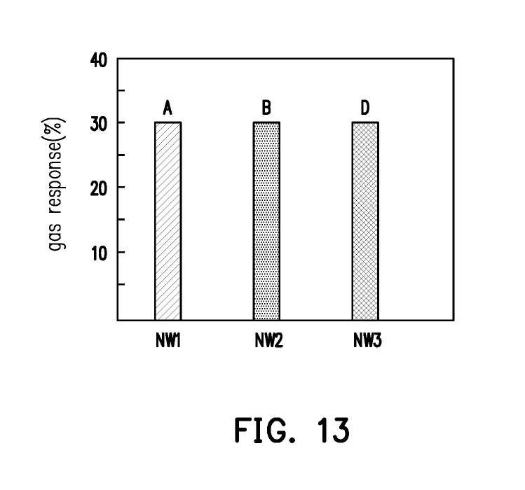

FIG. 13 is a bar chart illustrating different gas responses of nanowires with different widths to different gases in the embodiment of FIG. 2. In this embodiment, each nanowire is configured to sense one gas. For example, the nanowire NW1 senses the first gas A, the nanowire NW2 senses the second gas B, and the nanowire NW3 senses the fourth gas D. However, the number of sensible gases described herein shall not be construed as a limitation of the disclosure. From left to right, FIG. 13 illustrates the gas responses of the nanowires NW1, NW2, and NW3 to the first gas A, the second gas B, and the fourth gas D in sequence. In this embodiment, the first gas A, the second gas B, and the fourth gas D are respectively H₂, NH₃, and CH₄, for example. However, the types of the gases described herein serve as an example, and shall not be construed as a limitation of the disclosure. As shown in FIGS. 5 to 10, the gas responses of the nanowires NW1, NW2, and NW3 of the nanowire sensors 212_1, 212_2, and 212_3 to the first gas A, the second gas B, and the fourth gas D set to be the same. For example, the gas responses are all set at 30%. However, the values of the gas responses described herein shall not be construed as a limitation of the disclosure. In this embodiment, setting the gas responses of the nanowires NW1, NW2, and NW3 includes, but is not limited to, adjusting the structural properties or doped concentrations of the nanowires, for example. In this embodiment, the gas database 230 includes the reference data SR storing the gas responses shown in FIG. 13, for example, as basis for the gas determining circuit 220 to determine the types of the gases.

In the following, specific operations of the gas determining circuit and the gas database according to an exemplary embodiment of the disclosure are described in detail in the following.

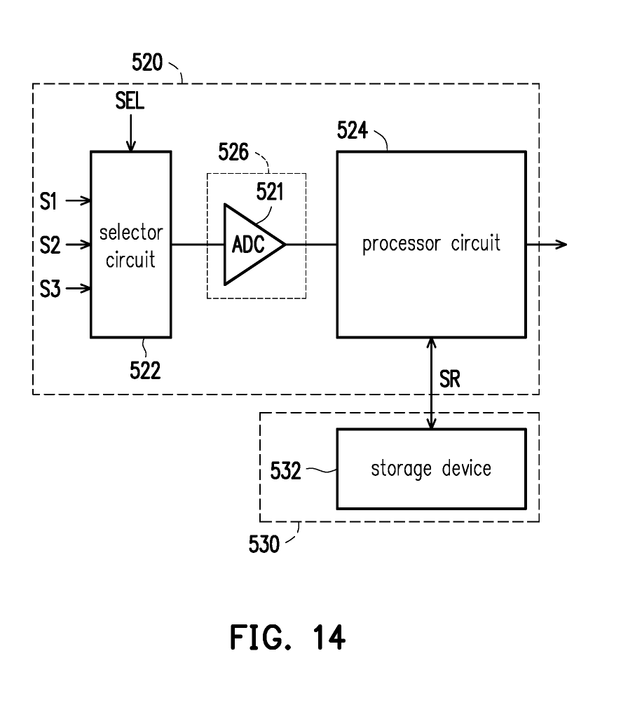

FIG. 14 is an internal schematic view illustrating a gas determining circuit and a gas database according to an embodiment of the disclosure. Referring to FIG. 14, the gas determining circuit 520 of this embodiment includes, for example, a selector circuit 522, a signal pre-processing circuit 526, and a processor circuit 524. The signal pre-processing circuit 526 includes an analog-to-digital converter circuit 521. The selector circuit 522 is coupled to a gas sensor, such as the gas sensors 210, 310, and 410 shown in FIGS. 2, 11, and 12. The analog-to-digital converter circuit 521 is coupled to the selector circuit 522. The processor circuit 524 is coupled to the analog-to-digital converter circuit 521.

In this embodiment, the selector circuit 522 is configured to receive the sensing signals S1, S2, and S3. The selector circuit 522 selects and outputs one of the sensing signals S1, S2, and S3 to the signal pre-processing circuit 526 sequentially or randomly based on a selection signal SEL, until the gas determining circuit 520 determines the types of the sensed gases. In this embodiment, some or all of the sensing signals S1, S2, and S3 are chosen, and the gas determining circuit 520 is able to determine the types of the sensed gases.

In this embodiment, the signal pre-processing circuit 526 may be configured to receive the sensing signal S1, S2, or S3 selected by the selector circuit 522, and perform a pre-processing operation to the sensing signal S1, S2, or S3. In this embodiment, the signal pre-processing circuit 526 includes the analog-to-digital converter circuit 521. The analog-to-digital converter circuit 521 is configured to receive the sensing signal S1, S2, or S3 selected by the selector circuit 522 and convert the sensing signal S1, S2, or S3 in an analog format into the sensing signal S1, S2, or S3 in a digital format, so as to output a signal processing result to the processor circuit 524. Thus, the signal pre-processing operation of this embodiment includes converting the sensing signal in the analog format into the sensing signal in the digital format, so as to generate the signal processing result.

In this embodiment, the processor circuit 524 receives the signal processing result including the sensing signal S1, S2, or S3 in the digital format. The processor circuit 524 receives the reference data SR from a gas database 530. The processor circuit 524 determines the types of the gases based on the reference data SR and at least one of the sensing signals S1, S2, and S3 in the digital format, so as to output a determination result. In this embodiment, the gas database 530 includes a storage device 532, for example. The storage device 532 is coupled to the gas determining circuit 520. The storage device 532 is configured to store the reference data SR and output the reference data SR to the gas determining circuit 520. In this embodiment, the storage device 532 stores the reference data SR including the gas responses of one or both of FIGS. 5 and 13 as the basis for the gas determining circuit 520 to determine the types of the gases. In this embodiment, the gas database 530 may further include suitable functional components such as a communication circuit and a power circuit, etc. However, the disclosure is not limited thereto.

In this embodiment, the processor circuit 524 includes a central processing unit (CPU), a microprocessor, a digital signal processor (DSP), a programmable controller, a programmable logic device (PLD), other similar devices, or the combination of the devices, for example. However, the disclosure is not limited thereto.

In this embodiment, the storage device 532 includes a flash drive, a memory card, a mechanical hard drive, a solid state drive (SSD), a cloud server, a secure digital (SD) card, a multimedia card (MMC) a memory stick, a compact flash (CF) card, an embedded storage device, other similar devices, or a combination of these devices, for example. However, the disclosure is not limited thereto. In this embodiment, the storage device 532 may further include suitable functional components such as a computation module, a storage module, a communication module, a power module, etc. However, the disclosure is not limited thereto.

In this embodiment, the selector circuit 522 and the analog-to-digital converter circuit 521 may be respectively implemented based on a circuit structure of any selector circuit and a circuit structure of any analog-to-digital converter circuit in this field. However, the disclosure does not intend to impose a limitation in this respect. The common knowledge of this field already provide sufficient teaching, suggestions, and descriptions of embodiment concerning internal circuit structures and implementation of the selector circuit 522 and the analog-to-digital converter circuit 521. Details in this respect are thus not repeated in the following.

In an embodiment, the gas determining circuit 502 may not include the selector circuit 522. In this embodiment, the signal pre-processing circuit 526 includes a plurality of analog-to-digital converter circuits 521 to respectively process the sensing signals S1, S2, and S3 and provide the signal processing result to the processor circuit 524.

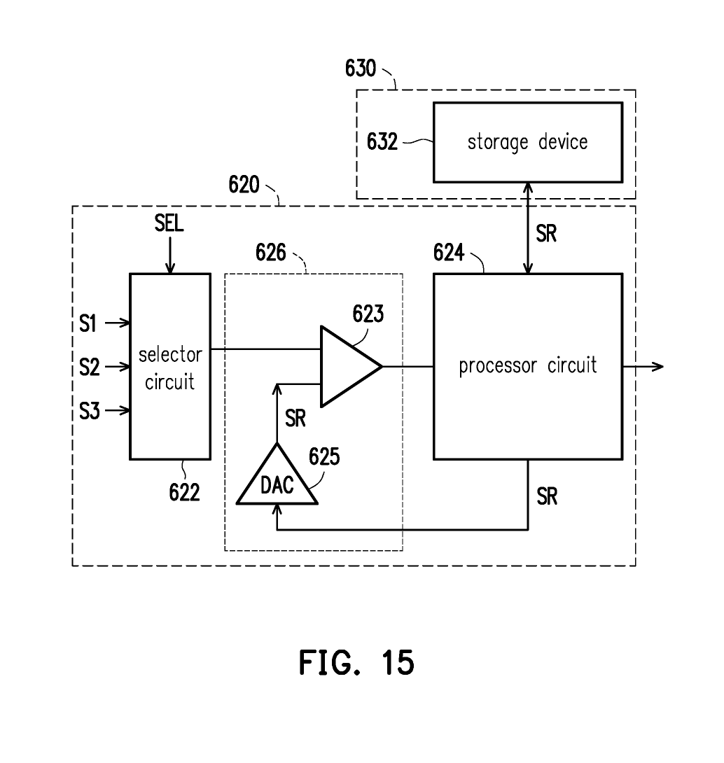

FIG. 15 is an internal schematic view illustrating a gas determining circuit and a gas database according to another embodiment of the disclosure. Referring to FIGS. 14 and 15, a gas determining circuit 620 of this embodiment is similar to the gas determining circuit 520 in the embodiment of FIG. 14, except for a main difference that a signal pre-processing circuit 626 of this embodiment further includes a comparator circuit 623 and a digital-to-analog converter circuit 625, for example.

In this embodiment, the comparator circuit 623 is coupled to a selector circuit 622 to receive the sensing signal S1, S2, or S3 selected by the selector circuit 622. The comparator circuit 623 compares the sensing signal S1, S2, or S3 and the reference data SR, so as to output a result of comparison to a processor circuit 624. In this embodiment, the digital-to-analog converter circuit 625 is coupled to the comparator circuit 623. The digital-to-analog converter circuit 625 is configured to receive the reference data SR output by the processor circuit 624 to convert the reference data SR in the digital format into the reference data SR in the analog format, so as to output the reference data SR in the analog format to the comparator circuit 623. Thus, in this embodiment, a signal processing operation of the signal pre-processing circuit 626 includes converting the reference data SR in the digital format into the reference data SR in the analog format to generate the reference data SR in the analog format, and comparing the sensing signal S1, S2, or S3 with the reference data SR to generate the result of comparison. In this embodiment, the processor circuit 624 outputs the reference data SR in the digital format to the digital-to-analog converter circuit 625, and receives the signal processing result including the result of comparison from the comparator circuit 623, so as to compare the types of the gases based on the result of comparison.

In this embodiment, the comparator circuit 623 and the digital-to-analog converter circuit 625 may be respectively implemented based on a circuit structure of any comparator circuit and any digital-to-analog converter circuit in this field. However, the disclosure does not intend to impose a limitation in this respect. Thus, the common knowledge of this field already provide sufficient teaching, suggestions, and descriptions of embodiment concerning internal circuit structures and implementation of the comparator circuit 623 and the digital-to-analog converter circuit 625. Details in this respect are thus not repeated in the following.

In the following, a gas sensing method according to an exemplary embodiment of the disclosure is described in the following.

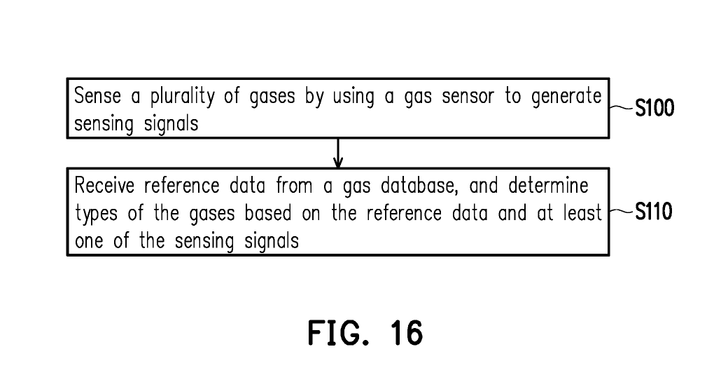

FIG. 16 is a flowchart illustrating a gas sensing method according to an embodiment of the disclosure. Referring to FIGS. 1 and 16, the gas sensing method of this embodiment is at least suitable for the gas sensing apparatuses in FIGS. 1, 2, 11 and 12 to sense a plurality of gases. According to the embodiment, at Step S100, the gas determining circuit 120 uses the gas sensor 130 to sense a plurality of gases to generate the sensing signals SS. The sensing signals SS include the plurality of sensing signals S1, S2, and S3, for example. Then, at Step S110, the gas determining circuit 120 receives the reference data SR from the gas database 130 and determines the types of the sensed gases based on the reference data SR and at least one of the sensing signals S1, S2, and S3.

Sufficient teaching, suggestions, and descriptions of embodiment concerning the gas sensing method according to the embodiment of the disclosure are already provided in the embodiments shown in FIGS. 1 to 15. Thus, details in this respect are not repeated in the following.

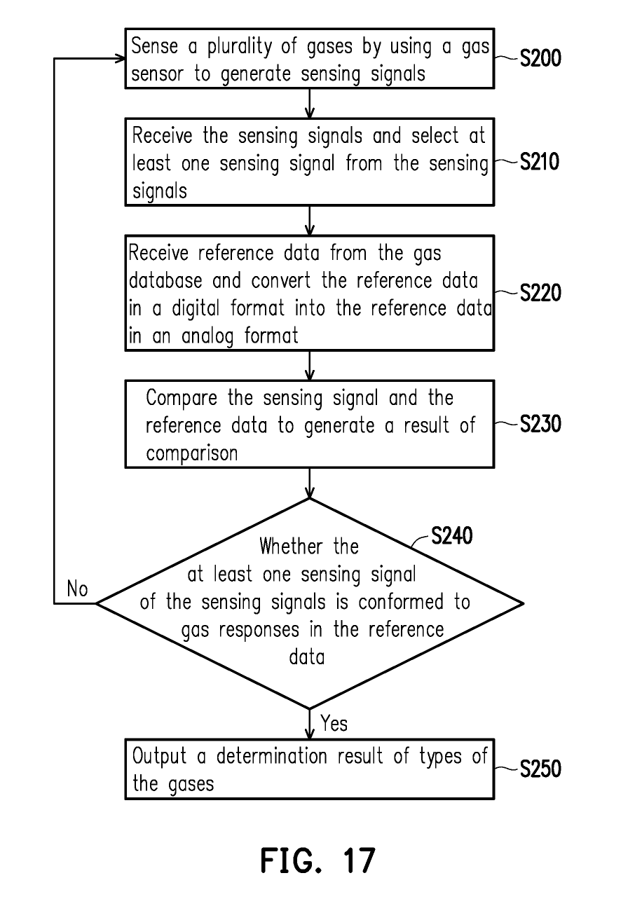

FIG. 17 is a flowchart illustrating a gas sensing method according to another embodiment of the disclosure. Referring to FIGS. 1 and 17, the gas sensing method of this embodiment is at least suitable for the gas sensing apparatuses 100, 200, 300, and 400 in FIGS. 1, 2, 11 and 12 to sense a plurality of gases. In this embodiment, the gas determining circuits 120, 220, 320 and 420 of the gas sensing apparatuses 100, 200, 300, and 400 shown in FIGS. 1, 2, 11, and 12 are implemented based on the internal circuit structure of the gas determining circuit 520 shown in FIG. 15, for example. In the following, the gas sensing method of this embodiment is described with reference to the gas determining circuit 520 shown in FIG. 14 and the gas sensing apparatus 100 shown in FIG. 1.

According to the embodiment, at Step S200, the gas determining circuit 520 uses the gas sensor 110 to sense a plurality of gases to generate the plurality of sensing signals S1, S2, and S3. Then, at Step S210, the gas determining circuit 520 receives the sensing signals S1, S2, and S3 and selects at least one sensing signal from the sensing signals S1, S2, and S3. Then, at Step S220, the gas determining circuit 520 receives the reference data SR from the gas database 530 and converts the reference data SR in the digital format into the reference data SR in the analog format. Then, at Step S230, the gas determining circuit 520 compares the sensing signal S1, S2, and S3 with the reference data SR to generate a result of comparison. The result of comparison includes whether the sensing signal S1, S2, or S3 is conformed to the gas responses of the reference data SR.

Then, at Step S240, the gas determining circuit 520 determines whether to output a determination result of gas type based on the result of comparison or return to Step S200 to sense the gas again. At Step S240, if the result of comparison shows that the at least one of the sensing signals S1, S2, and S3 is conformed to the gas responses of the reference data SR, the gas determining circuit 520 executes Step S250 to output the determination result of gas type. At Step S240, if the comparison result shows that the at least one of the sensing signals S1, S2, and S3 is not conformed to the gas responses of the reference data SR, the gas determining circuit 520 returns to Step S200 to sense the gas again.

Sufficient teaching, suggestions, and descriptions of embodiment concerning the gas sensing method according to the embodiment of the disclosure are already provided in the embodiments shown in FIGS. 1 to 16. Thus, details in this respect are not repeated in the following.

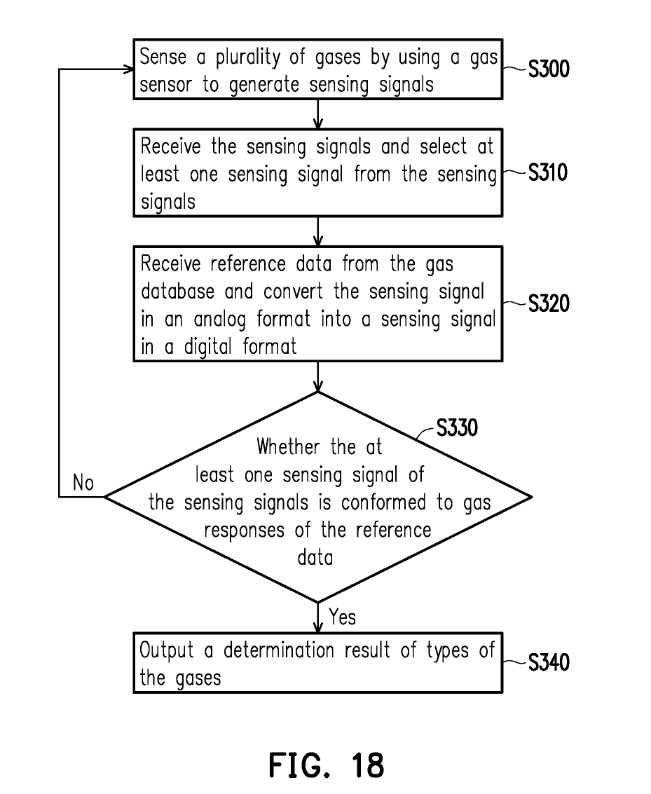

FIG. 18 is a flowchart illustrating a gas sensing method according to another embodiment of the disclosure. Referring to FIGS. 1 and 18, the gas sensing method of this embodiment is at least suitable for the gas sensing apparatuses 100, 200, 300, and 400 in FIGS. 1, 2, 11 and 12 to sense a plurality of gases. In this embodiment, the gas determining circuits 120, 220, 320 and 420 of the gas sensing apparatuses 100, 200, 300, and 400 shown in FIGS. 1, 2, 11, and 12 are implemented based on the internal circuit structure of the gas determining circuit 620 shown in FIG. 15, for example. In the following, the gas sensing method of this embodiment is described with reference to the gas determining circuit 620 shown in FIG. 15 and the gas sensing apparatus 100 shown in FIG. 1.

According to the embodiment, at Step S300, the gas determining circuit 620 uses the gas sensor 110 to sense a plurality of gases to generate the plurality of sensing signals S1, S2, and S3. Then, at Step S310, the gas determining circuit 620 receives the sensing signals S1, S2, and S3 and selects at least one sensing signal from the sensing signals S1, S2, and S3. Then, at Step S320, the gas determining circuit 620 receives the reference data SR from the gas database 630 and converts the sensing signal S1, S2, or S3 in the analog format into the sensing signal S1, S2, or S3 in the digital format.

Then, at Step S330, the gas determining circuit 520 determines the types of the gases based on the reference data SR and the sensing signal S1, S2, or S3. At Step S330, if the at least one of the sensing signals S1, S2, and S3 is conformed to the gas responses of the reference data SR, the gas determining circuit 620 executes Step S340 to output a determination result of gas type. At Step S330, if the sensing signals S1, S2, and S3 are not conformed to the gas responses of the reference data SR, the gas determining circuit 620 returns to Step S300 to sense the gas again.

Sufficient teaching, suggestions, and descriptions of embodiment concerning the gas sensing method according to the embodiment of the disclosure are already provided in the embodiments shown in FIGS. 1 to 17. Thus, details in this respect are not repeated in the following.

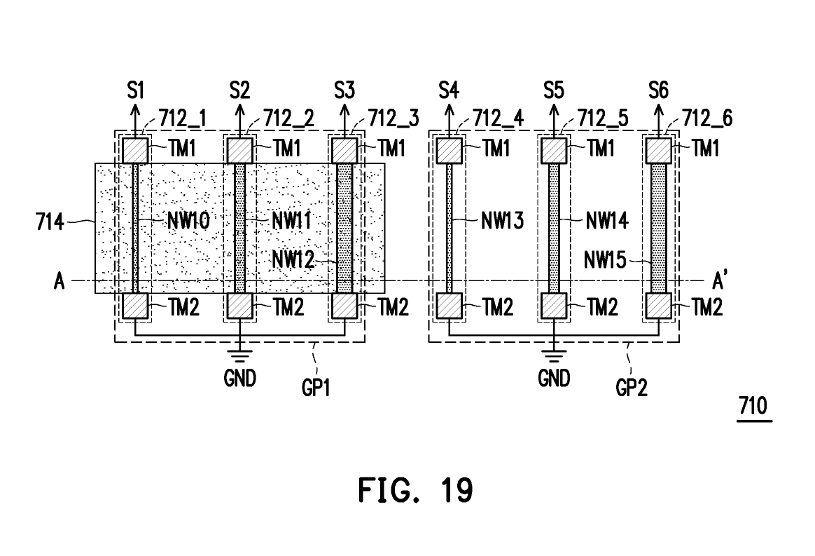

However, the structure of the gas sensor is not limited to the above-mentioned structures. The gas sensor may have other structures in other embodiments described hereinafter. FIG. 19 is a schematic view illustrating a structure of a gas sensor in another embodiment of the disclosure. A gas sensor 710 in FIG. 19 is similar to the gas sensor 210 in FIG. 2, the differences are described hereinafter. The gas sensor 710 includes two first and second nanowire sensor groups GP1 and GP2, but the number of nanowire sensor groups may be more than two, the disclosure is not limited thereto. The first nanowire sensor group GP1 includes a plurality of nanowire sensors 712_1, 712_2, and 712_3, and the second nanowire sensor group GP2 includes a plurality of nanowire sensors 712_4, 712_5, and 712_6. The nanowire sensors 712_1, 712_2, 712_3, 712_4, 712_5, and 712_6 respectively include nanowires NW10, NW11, NW12, NW13, NW14, and NW15. The nanowires NW10, NW11, and NW12 have the same profile but different widths, for example. Similarly, the nanowires NW13, NW14, and NW15 have the same profile but different widths, for example. In one embodiment, the profiles and materials of nanowires NW10, NW11, NW12, NW13, NW14, and NW15 are the same, the widths of the nanowires NW10 and NW13 are equal to each other, the widths of the nanowires NW11 and NW14 are equal to each other, and the widths of the nanowires NW12 and NW153 are equal to each other, but the disclosure is not limited thereto. In addition, the nanowires NW10, NW11, NW12 of the first nanowire sensor group GPI are covered by an isolation layer 714, so the nanowires NW10, NW11, NW12 are isolated from gases. The nanowire sensors 712_1, 712_2, and 712_3 of the first nanowire sensor group GP1 are configured to output sensing signals S1, S2, and S3 to a gas determining circuit. The nanowires NW13, NW14, and NW15 of the second nanowire sensor group GP2 are exposed to gases, so the nanowire sensors 712_4, 712_5, and 712_6 are configured to sense gases and output sensing signals S4, S5, and S6 to the gas determining circuit. Therefore, the sensing signals S1, S2, and S3 serve as reference or baseline to the sensing signals S4, S5, and S6, respectively.

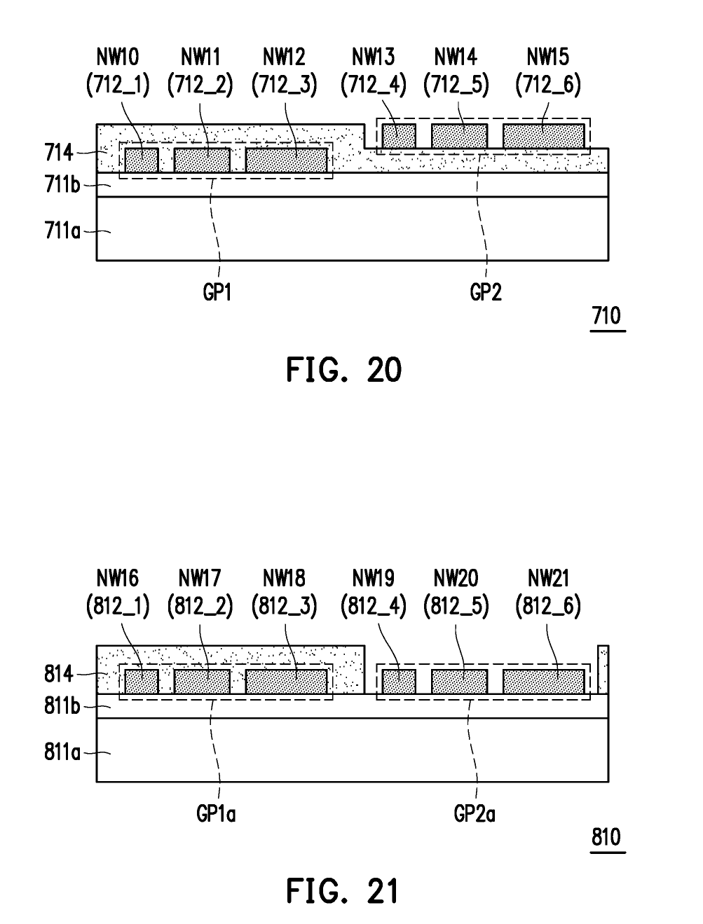

FIG. 20 is a cross-sectional view of the gas sensor along section line A-A′ in FIG. 19. As shown in FIG. 20, the gas sensor 710 further includes a substrate 711a, a bottom isolation layer 711b disposed on the substrate 711a. The nanowires NW10 to NW12 are disposed on the bottom isolation layer 711b and are covered by the isolation layer 714. The nanowires NW13, NW14, and NW15 are disposed on the isolation layer 714, and more specifically in a recess of the isolation layer 714, for example. Hence, the nanowires NW10 to NW12 are isolated from gases outside, the nanowires NW13 to NW15 are exposed to gases outside, and the nanowire sensors 712_1, 712_2, and 712_3 are isolated from the nanowire sensors 712_4, 712_5, and 712_6 by the isolation layer 714. That is to say, the sensing signals S1, S2, and S3 of the nanowire sensors 712_1, 712_2, and 712_3 are not affected by the gases outside and can serve as reference or baseline to the sensing signals S4, S5, and S6 of the nanowire sensors 712_4, 712_5, and 712_6. In one embodiment, the nanowires NW10 to NW12 and the nanowires NW13 to NW15 are disposed on the same substrate of the same chip and have the same wafer level, but the nanowires NW10 to NW12 of the first nanowire sensor group GP1 and the nanowires NW13 to NW15 of the second nanowire sensor group GP2 are disposed on different isolation layers. To be more specific, the nanowires NW10 to NW12 of the first nanowire sensor group GP1 are disposed on the bottom isolation layer 711b, and the nanowires NW13 to NW15 of the second nanowire sensor group GP2 are disposed on the isolation layer 714.

FIG. 21 is a cross-sectional view of a gas sensor in another embodiment of the disclosure. A gas sensor 810 in FIG. 21 is similar to the gas sensor 710 in FIG. 20, the differences are described hereinafter. A plurality of nanowires NW16, NW17, and NW18 of nanowire sensors 812_1, 812_2, and 812_3 in a first nanowire sensor group GP1a are disposed on a bottom isolation layer 811b, which is disposed on a substrate 811a, and covered by an isolation layer 814. In addition, a plurality of nanowires NW19, NW20, and NW21 of nanowire sensors 812_4, 812_5, and 812_6 in a second nanowire sensor group GP2a are also disposed on the bottom isolation layer 811b and exposed to gases outside. That is to say, in one embodiment, the nanowires NW16 to NW18 of the first nanowire sensor group GP1a and the nanowires NW19 to NW21 of the second nanowire sensor group GP2a are all disposed on the bottom isolation layer 811b.

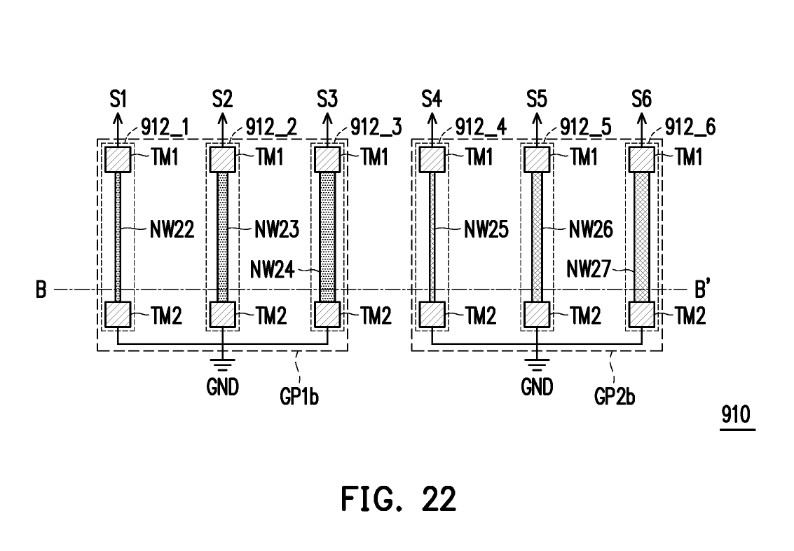

FIG. 22 is a schematic view illustrating a structure of a gas sensor in another embodiment of the disclosure. A gas sensor 910 in FIG. 22 is similar to the gas sensor 710 in FIG. 19, the differences are described hereinafter. As shown in FIG. 22, a plurality of nanowires NW22, NW23, and NW24 of nanowire sensors 912_1, 912_2, and 912_3 in a first nanowire sensor group GP1b and a plurality of nanowires NW25, NW26, and NW27 of nanowire sensors 912_4, 912_5, and 912_6 in a second nanowire sensor group GP2b are all exposed to the gases outside. The nanowires NW22, NW23, and NW24 of the first nanowire sensor group GP1b are configured to sense gases, so as to output sensing signals S1, S2, and S3 to the gas determining circuit. Similarly, the nanowires NW25, NW26, and NW27 of the second nanowire sensor group GP2b are configured to sense gases, so as to output sensing signals S4, S5, and S6 to the gas determining circuit. The nanowires NW22, NW23, and NW24 of the first nanowire sensor group GP1b are made of the same sensing material, and the nanowires NW25, NW26, and NW27 of the second nanowire sensor group GP2b are also made of the same sensing material. However, in one embodiment, the sensing material of the nanowires NW22, NW23, and NW24 in the first nanowire sensor group GP1b is different from the sensing material of the nanowires NW25, NW26, and NW27 in the second nanowire sensor group GP2b. Therefore, the types of the gases are determined based on not only the comparing the sensing signals S1 to S3 with the reference data SR, but also comparing the sensing signals S4 to S6 with the reference data SR, so as to improve accuracy and assist in correcting determination result. As a result, the gas determining circuit may accurately determine the types of the gases.

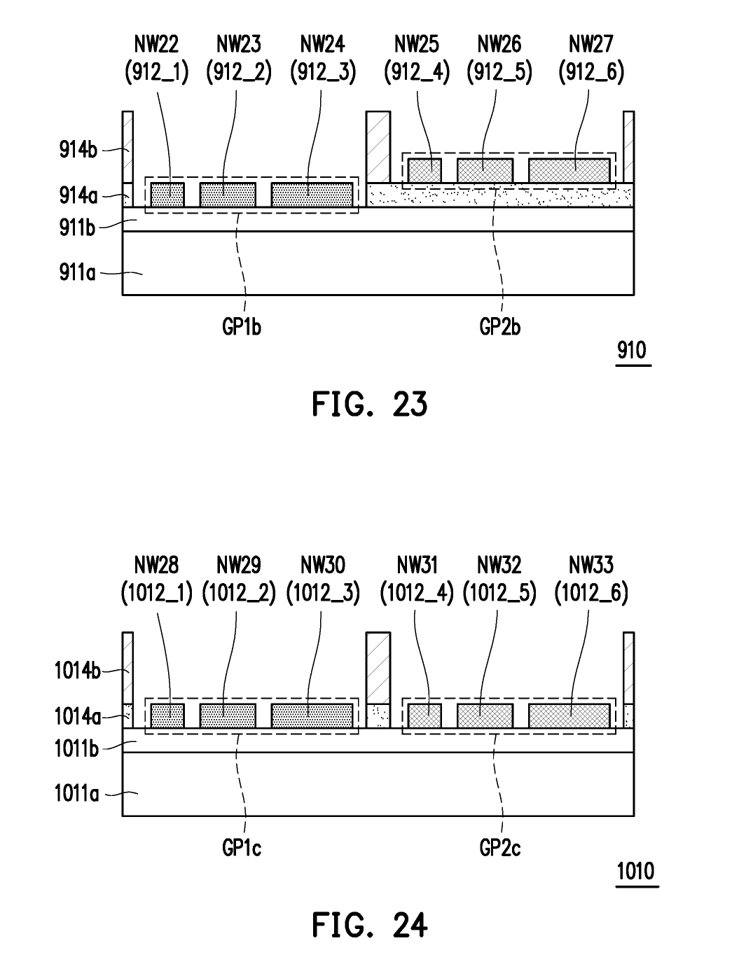

FIG. 23 is a cross-sectional view of the gas sensor along section line B-B′ in FIG. 22. As shown in FIG. 23, the gas sensor 910 further includes a substrate 911a, a bottom isolation layer 911b disposed on the substrate 911a. The nanowires NW22, NW23, and NW24 in the first nanowire sensor group GP1b are disposed on the bottom isolation layer 911b, a first isolation layer 914a is also disposed on the bottom isolation layer 911b and exposes the nanowires NW22, NW23, and NW24. In other words, the nanowires NW22, NW23, and NW24 of the first nanowire sensor group GP1b are disposed in a hole/cavity of the first isolation layer 914a and on the bottom isolation layer 911b. In addition, the nanowires NW25, NW26, and NW27 in the second nanowire sensor group GP2b are disposed on the first isolation layer 914a, and a second isolation layer 914b is also disposed on the first isolation layer 914a. The second isolation layer 914b exposes the nanowires NW25, NW26, and NW27 in the second nanowire sensor group GP2b and also exposes the nanowires NW22, NW23, and NW24 in the first nanowire sensor group GP1b. In another words, the nanowires NW25, NW26, and NW27 in the second nanowire sensor group GP2b are disposed in a hole/cavity of the second isolation layer 914b and disposed on the first isolation layer 914a, and the second isolation layer 914b further has another hole/cavity aligning with the hole/cavity, which the nanowires NW22, NW23, and NW24 of the first nanowire sensor group GP1b are disposed in, of the first isolation layer 914a. Therefore, the nanowires NW22 to NW24 of the first nanowire sensor group GP1b and the nanowires NW25 to NW27 of the second nanowire sensor group GP2b are exposed to and configured to sense the gases outside.

FIG. 24 is a cross-sectional view of a gas sensor in yet another embodiment of the disclosure. A gas sensor 1010 in FIG. 24 is similar to the gas sensor 910 in FIG. 23, the differences are described hereinafter. A plurality of nanowires NW28, NW29, and NW30 of nanowire sensors 1012_1, 1012_2, and 1012_3 in a first nanowire sensor group GP1c are disposed on a bottom isolation layer 1011b, which is disposed on a substrate 1011a. In addition, a plurality of nanowires NW31, NW32, and NW33 of nanowire sensors 1012_4, 1012_5, and 1012_6 in a second nanowire sensor group GP2c are also disposed on the bottom isolation layer 1011b. A first isolation layer 1014a is disposed on the bottom isolation layer 1011b, and a second isolation layer 1014b is disposed on the first isolation layer 1014a. The first isolation layer 1014a and the second isolation layer 1014b both expose the nanowires NW28 to NW30 of the first nanowire sensor group GP1c and the nanowires NW31 to NW33 of the second nanowire sensor group GP2c to the gases outside. In other words, the nanowires NW28 to NW30 of the first nanowire sensor group GP1c is disposed in one hole/cavity, which is aligned with a hole/cavity of the second isolation layer 1014b, of the first isolation layer 1014a. Additionally, the nanowires NW31 to NW33 of the second nanowire sensor group GP2c is disposed in another hole/cavity, which is aligned with another hole/cavity of the second isolation layer 1014b, of the first isolation layer 1014a. As a result, the nanowires NW28 to NW30 of the first nanowire sensor group GP1c and the nanowires NW31 to NW33 of the second nanowire sensor group GP2c are exposed to the gases outside, and the nanowire sensors 1012_1 to 1012_3 of the first nanowire sensor group GP1c and the nanowire sensors 1012_4 to 1012_6 of the second nanowire sensor group GP2c are configured to sense the gases outside.

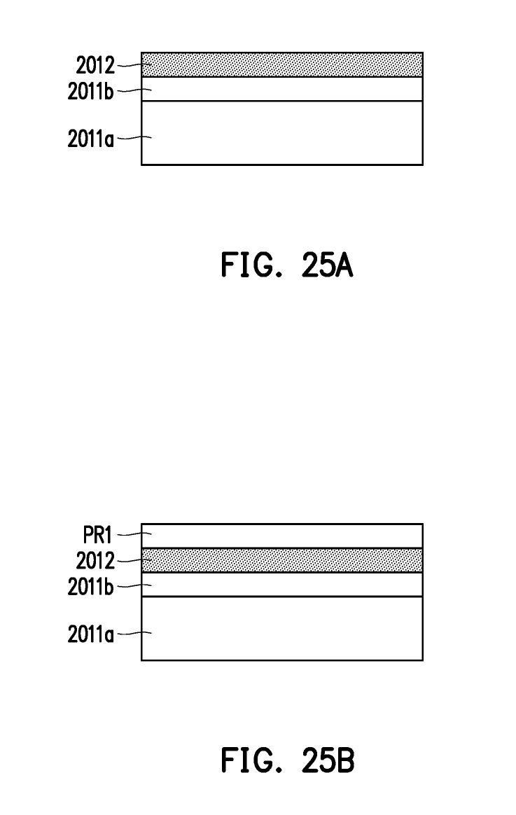

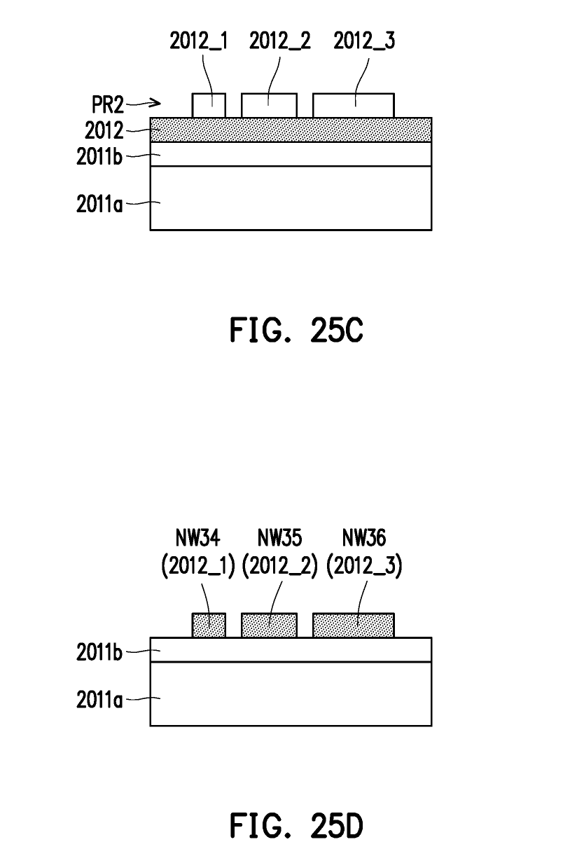

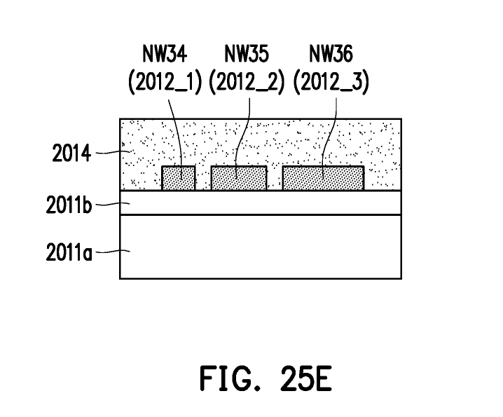

Furthermore, a manufacturing process of a gas sensing apparatus is described as follows. The gas sensing apparatus has n nanowire sensor groups, wherein n is an integer greater than 1. Referring to FIG. 25A, a substrate 2011a is provided in Step S1000, an isolation layer 2011b is disposed on the substrate 2011a in Step S1100, and a sensing layer 2012 is disposed on the isolation layer 2011b in Step S1200. Next, referring to FIG. 25B, a photoresist layer PR1 is coated on the sensing layer 2012 in Step S1300, the photoresist layer PR1 may be a positive or negative photoresist layer, the disclosure is not limited thereto. In the following FIG. 25C, the photoresist layer PR1 is patterned to form a patterned photoresist layer PR2 in Step S1400 by using photomask and ultraviolet (UV) light, for example. Next, in Step S1500, the sensing layer 2012 is etched according to the patterned photoresist layer PR2, and the patterned photoresist layer PR2 is removed, as shown in FIG. 25D. In the disclosure, the dry etching process or the wet etching process may be adopted to etch the sensing layer 2012, the patterned photoresist layer PR2 may be removed by plasma ashing and stripping, the etching method and the photoresist removal method are not limited in the disclosure. At this time, a plurality of nanowires NW34, NW35, and NW36 of nanowire sensors 2012_1, 2012_2, and 2012_3 in one nanowire sensor group are formed. Subsequently, referring to FIG. 25E, another isolation layer 2014 is disposed on and covers the bottom isolation layer 2011b and the nanowires NW34, NW35, and NW36 in Step 1600. At Step 1700, it is determined whether a plurality of nanowires of another nanowire sensor group need to be formed or not. If a plurality of nanowires of another nanowire sensor group need to be formed (for example, the number of formed nanowire sensor groups is smaller than n), the process returns to the Step S1200, and Steps S1200 to S1600 are performed again to form a plurality of nanowires of another nanowire sensor group. At Step 1700, if there is no need to form a plurality of nanowires of another nanowire sensor group (for example, the number of formed nanowire sensor groups is equal to n), Step S1800 is performed. At the Step S1800, it is determined whether the nanowires of each nanowire sensor group are used for reference or sensing gases. If the nanowires of one nanowire sensor group are used for sensing gases, the nanowires of that nanowire sensor group are exposed to gases outside in Step S1900, and then the process stops. If the nanowires of one nanowire sensor group are used for reference, the nanowires of that nanowire sensor group are not exposed to the gases outside. The above-mentioned manufacturing process of the gas sensing apparatus may be used to form the gas sensor 710 in FIG. 20, the gas sensor 810 in FIG. 21, the gas sensor 910 in FIG. 23, or the gas sensor 1010 in FIG. 24. It should be noted here, each of the gas sensor 710 in FIG. 20, the gas sensor 810 in FIG. 21, the gas sensor 910 in FIG. 23, and the gas sensor 1010 in FIG. 24 has two nanowire sensor groups. The disclosure is not limited thereto.

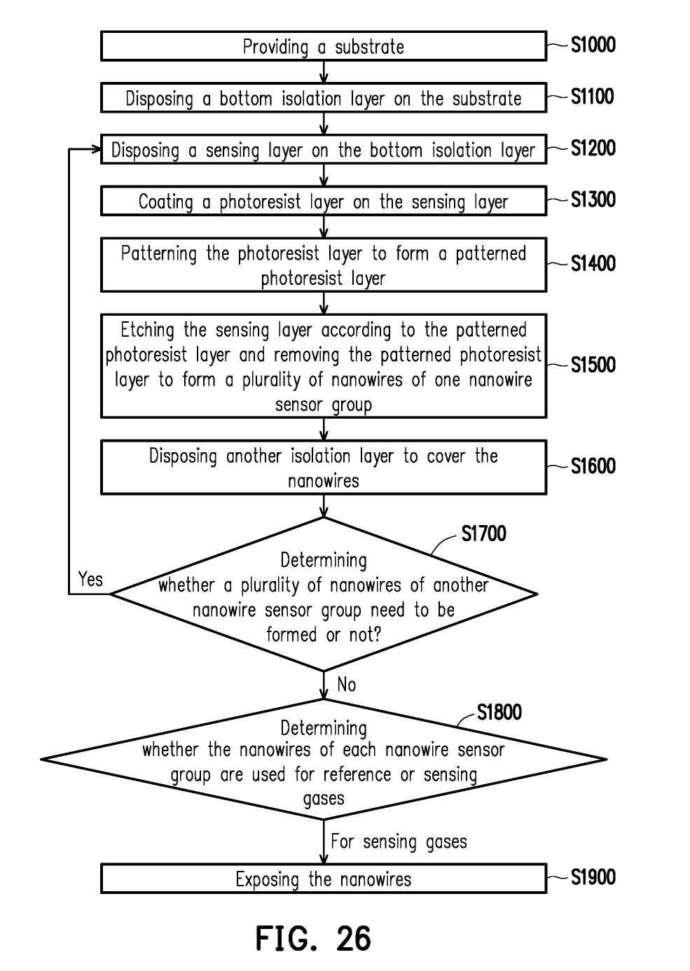

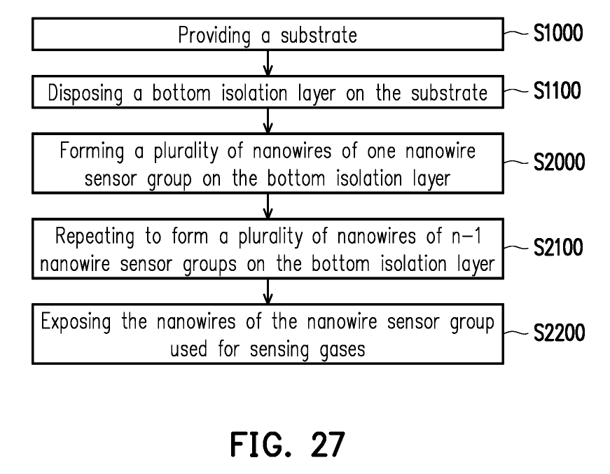

In other words, the Step S1200 to S1600 are used to form the nanowires of one nanowire sensor group, and the Step S1200 to S1600 are repeated n times to form the nanowires of n nanowire sensor groups, n is an integer greater than 1. That is to say, the manufacturing process of the gas sensing apparatus may be described in a different way in FIG. 27, wherein the gas sensing apparatus has n nanowire sensor groups and n is an integer greater than 1. As shown in FIG. 25A and FIG. 27, the substrate 2011a is provided in Step S1000, the isolation layer 2011b is disposed on the substrate 2011a in Step S1100. Next, a plurality of nanowires NW34 to NW36 of one nanowire sensor group are formed on the bottom isolation layer in Step S2000, as shown in FIGS. 25A to 25E. It should be noted here, the Step S2000 is equivalent to Steps S1200 to Step S1600 in FIG. 26. Furthermore, repeating Step 2000 to form a plurality of nanowires of n−1 nanowire sensor groups on the bottom isolation layer in Step 2100. It should be noted here, the Step S2000 and Step 2100 in FIG. 27 are equivalent to Steps S1200 to Step S1700 in FIG. 26. Finally, the nanowires of the nanowire sensor group used for sensing gases are exposed in Step 2200. For example, the nanowires NW19 to NW21 of the second nanowire sensor group GP2a are exposed in FIG. 21, and the nanowires NW22 to NW24 of the first nanowire sensor group GP1b and the nanowires NW25 to NW27 of the second nanowire sensor group GP2b are all exposed in FIG. 23. It should be noted here, the Step S2200 in FIG. 27 is equivalent to Steps S1800 to Step S1900 in FIG. 26.

That is to say, by using the above-mentioned manufacturing process of the gas sensing apparatus, a plurality of nanowire sensors in one nanowire sensor group are formed simultaneously one the same plane by semiconductor planar technology, a plurality of nanowire sensor groups having nanowire sensors made of the same sensing material are formed by photolithography processes and are formed on the same plane or different planes in wafer level of the same chip, and a plurality of nanowire sensor groups having nanowire sensors made of different sensing materials are formed on the same plane or different planes in wafer level of the same chip.

In view of the foregoing, in the exemplary embodiment of the disclosure, the gas sensing apparatus includes the plurality of nanowire sensors. In the method for the gas sensing apparatus to determine the types of the gases, the types of the gases are determined based on the concept that the nanowires having different structural properties have different gas responses to the same gas, whereas the nanowires having the same structural properties have different gas responses to different gases. Based on this concept, the nanowire sensors may be manufactured on one chip to detect and determine the concentrations and types of gases. The gas sensing apparatus according to the exemplary embodiment of the disclosure has a low area cost and a quick response, and is capable of monitoring and determining the gases simultaneously.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A gas sensing apparatus, comprising:
a gas sensor, comprising two nanowire sensor groups and configured to sense a plurality of gases and output a plurality of sensing signals;
a gas determining circuit, coupled to the gas sensor and configured to receive the sensing signals and determine types of the gases based on reference data and at least one of the sensing signals; and
a gas database, coupled to the gas determining circuit and configured to store the reference data and output the reference data to the gas determining circuit,
wherein each of the nanowire sensor groups comprises a plurality of nanowire sensors, each of the nanowire sensors comprises at least one nanowire, and the nanowires have different structural properties,
wherein the nanowires in each of the nanowire sensor groups are made of a same sensing material, and
wherein the sensing material of the nanowires in one of the nanowire sensor groups is the same as the sensing material of the nanowires in another one of the nanowire sensor groups.

2. The gas sensing apparatus as claimed in claim 1, wherein the structural properties of the nanowires comprise at least one of width, length, height, and profile.

3. The gas sensing apparatus as claimed in claim 1, wherein the nanowires have different doped concentrations.

4. The gas sensing apparatus as claimed in claim 1, wherein each of the nanowire sensors is configured to sense a plurality of gases of the gases, and combinations of gas responses of the nanowire sensors to the gases are different.

5. The gas sensing apparatus as claimed in claim 4, wherein the respective nanowire sensors have different gas responses to the gases.

6. The gas sensing apparatus as claimed in claim 1, wherein each of the nanowire sensors is configured to sense one corresponding gas of the gases, and gas responses of the respective nanowire sensors to the respectively corresponding gases are the same.

7. The gas sensing apparatus as claimed in claim 1, wherein the nanowires in one of the nanowire sensor groups are exposed to the gases, and the nanowires in another one of the nanowire sensor groups are isolated from the gases.

8. The gas sensing apparatus as claimed in claim 1, wherein the nanowires in one of the nanowire sensor groups and the nanowires in another one of the nanowire sensor groups are disposed on a same plane in a same chip.

9. The gas sensing apparatus as claimed in claim 1, wherein the nanowires in one of the nanowire sensor groups and the nanowires in another one of the nanowire sensor groups are disposed on different planes in a same chip.

10. A gas sensing apparatus, comprising:
a gas sensor, comprising two nanowire sensor groups and configured to sense a plurality of gases and output a plurality of sensing signals;
a gas determining circuit, coupled to the gas sensor and configured to receive the sensing signals and determine types of the gases based on reference data and at least one of the sensing signals; and
a gas database, coupled to the gas determining circuit and configured to store the reference data and output the reference data to the gas determining circuit,
wherein each of the nanowire sensor groups comprises a plurality of nanowire sensors, each of the nanowire sensors comprises at least one nanowire, and the nanowires have different structural properties,
wherein the nanowires in each of the nanowire sensor groups are made of a same sensing material, and
wherein the sensing material of the nanowires in one of the nanowire sensor groups is different from the sensing material of the nanowires in another one of the nanowire sensor groups.

11. The gas sensing apparatus as claimed in claim 10, wherein the nanowires in the nanowire sensor groups are all exposed to the gases.

12. A manufacturing process of a gas sensing apparatus, the gas sensing apparatus having n nanowire sensor groups, wherein n is an integer greater than 1, comprising:
providing a substrate;
disposing a bottom isolation layer on the substrate;
forming a plurality of nanowires of one nanowire sensor group on the bottom isolation layer;
repeating to form a plurality of nanowires of n−1 nanowire sensor groups on the bottom isolation layer; and
exposing the nanowires of the nanowire sensor group used for sensing gases.

13. A manufacturing process of a gas sensing apparatus as claimed in claim 12, wherein step of forming the plurality of nanowires of one nanowire sensor group comprises:
disposing a sensing layer on the bottom isolation layer;
coating a photoresist layer on the sensing layer;
patterning the photoresist layer to form a patterned photoresist layer;
etching the sensing layer according to the patterned photoresist layer and removing the patterned photoresist layer to form a plurality of nanowires of one nanowire sensor group; and
disposing another isolation layer to cover the nanowires.
